(19) United States
(12) Patent Application Publication
(10) Pub. No.: US 2011/0043143 A1
(43) Pub. Date: Feb. 24, 2011

(54) Speed and Power Control Mechanisms for Battery Powered DC Motor

(76) Inventor: Daniel J. Alter, DeRuyter, NY (US)

Correspondence Address: BOND, SCHOENECK & KING, PLLC, ONE LINCOLN CENTER, SYRACUSE, NY, 13202-1355, US

(21) Appl. No.: 12/862,173

(22) Filed: Aug. 24, 2010

Related U.S. Application Data
(60) Provisional application No. 61/275,017, filed on Aug. 24, 2009.

(51) Int. Cl. H02K 7/14; H02P 1/04

(52) U.S. Cl. 318/3; 318/139

(57) ABSTRACT

A speed and power control mechanisms for battery powered DC motors including a plurality of batteries structured to be configured in series, parallel, or series/parallel wiring configurations/combinations, a selectable switch, relay, or contractor structured to wire the batteries in the series, parallel, or series/parallel wiring configurations/combinations based on the setting of the selectable switch, relay, or contractor to deliver various selected voltage levels, and thus various selected power and speed levels to a motor.

### RELATED APPLICATION

The present application claims priority to U.S. provisional patent application No. 61/275,017, filed on Aug. 24, 2009; all of the foregoing patent-related document(s) are hereby incorporated by reference herein in their respective entirety(ies).

### BACKGROUND OF THE INVENTION

1. Field of the Invention

The present invention relates to battery powered DC motors and, more particularly, to speed and power control mechanisms for battery powered DC motors.

2. Description of the Related Art

It is conventional for lawn mower motors to be gas powered, electric powered, and/or battery powered.

### SUMMARY OF THE INVENTION

The present invention recognizes that there are potential problems and/or disadvantages in the above-referenced gas powered, electric powered, and battery powered lawn mowers. One potential problem is that gas powered lawn mowers burn fossil fuels, pollute the environment, and potentially contribute to global warming. Another potential problem is that electric powered lawn mowers are typically underpowered. Plug-in lawn mowers are limited to a typical house circuit that is normally 20 Amps. Low power output is by design. A related problem is that battery powered lawn mowers suffer from short battery life, because battery powered mowers have all been designed to run on full power only. Various embodiments of the present invention may be advantageous in that they may solve or reduce one or more of the potential referenced problems and/or disadvantages discussed above.

It is therefore a principal object and advantage of the present invention to provide a non-fossil fuel burning lawn mower motor, which is more powerful as compared to conventional lawn mower motors while saving battery power when desired.

It is another object and advantage of the present invention to provide an operator of the lawn mower with the ability to control the speed and power of a lawn mower motor in such a way as to use either a full (higher) power/speed level or lower power/speed levels based upon a particular required/desired application, e.g., full power/speed when the cutting of thicker/taller grass and/or climbing a steep hill is required, or lower power/speed when battery power conservation and longer run time (while, e.g., using the same batteries) is desired and the application so permits (e.g., flat plane and/or shorter not as thick grass). Thus, it is an object and advantage of the present invention to provide an operator of the lawn mower with the ability to select a speed/power that meets the mowing need and in turn save battery power for when it is needed, i.e., select a power/speed level to match the job application.

In accordance with the foregoing objects and advantages, an embodiment of the present invention provides a speed and power control mechanism for battery powered DC (cordless) motors including, but nor limited to, a switch (e.g., toggle switch), contractor, or switching relay that dictates/changes the wiring of a plurality of batteries to various series or parallel configurations (e.g., through the closing and opening of set(s) of electrical contacts). This change in the wiring of the batteries results in the delivery of the desired voltage levels, and thus the power, which are applied to the battery powered DC motor. This change in the power output of the motor allows the motor to, e.g., increase/decrease the power/speed to the blades of the lawn mower, and to increase/decrease the power/speed to the drive mechanism and wheels of the lawn mower. In either the series or parallel configuration, the entire battery capacity can be utilized. This allows the user of the speed and power control mechanism for battery powered DC motors of an embodiment of the present invention to better control battery drain.

By selecting a setting of a switch that in turn changes the voltage/power delivered to the motor, an operator can control how long the batteries stored power will last. Thus, for example, when the operator wants to conserve battery power when going through sections of grass that do not need full power/speed or if only mulching leaves is the task, the operator can select lower power. By using multiple batteries and switching them in different series and parallel combinations it is possible to attain multiple power levels while still using all of the available battery power. This results in varied voltages at the DC motor and selective desired blade speed for the mowing application. More voltage, more speed. Less voltage less speed, but longer battery run time. In addition to the advantage stated above—all of the batteries could be equally depleted and could then be in need of very similar charging times.

### BRIEF DESCRIPTION OF THE DRAWINGS

The present invention will be more fully understood and appreciated by reading the following Detailed Description in conjunction with the accompanying drawings, in which:

FIG. 1A-C is a schematic of serial, parallel, and serial/parallel configurations of the speed and power control mechanism for a battery powered DC motor with two and four batteries, in accordance with an embodiment of the present invention.

FIG. 1D-F is a schematic of serial and serial/parallel configurations of the speed and power control mechanism for a battery powered DC motor with three batteries, in accordance with an embodiment of the present invention.

FIG. 2 is a schematic of the circuitry of the speed and power control mechanism for a battery powered DC motor with two batteries, in accordance with an embodiment of the present invention.

FIG. 3 is a schematic of the circuitry of the speed and power control mechanism for a battery powered DC motor with two batteries and a toggle switch, in accordance with an embodiment of the present invention.

FIG. 4 is a schematic of the circuitry of the speed and power control mechanism for a battery powered DC motor with three batteries, in accordance with an embodiment of the present invention.

FIG. 5 is a schematic of a three battery control circuit, with respect to the three battery mechanism as shown in described with respect to FIG. 4, in accordance with an embodiment of the present invention.

### DETAILED DESCRIPTION

The present invention will be more fully understood and appreciated by reading the following Detailed Description in conjunction with the accompanying drawings, wherein like reference numerals refer to like components.

As shown and described herein, in accordance with an embodiment of the present invention, the speed and power control mechanism for battery powered DC motors of an embodiment of the present invention can deliver selected voltages (and thus power) to a DC motor by wiring the batteries in various combinations of serial and parallel configurations, all while using the same battery capacity.

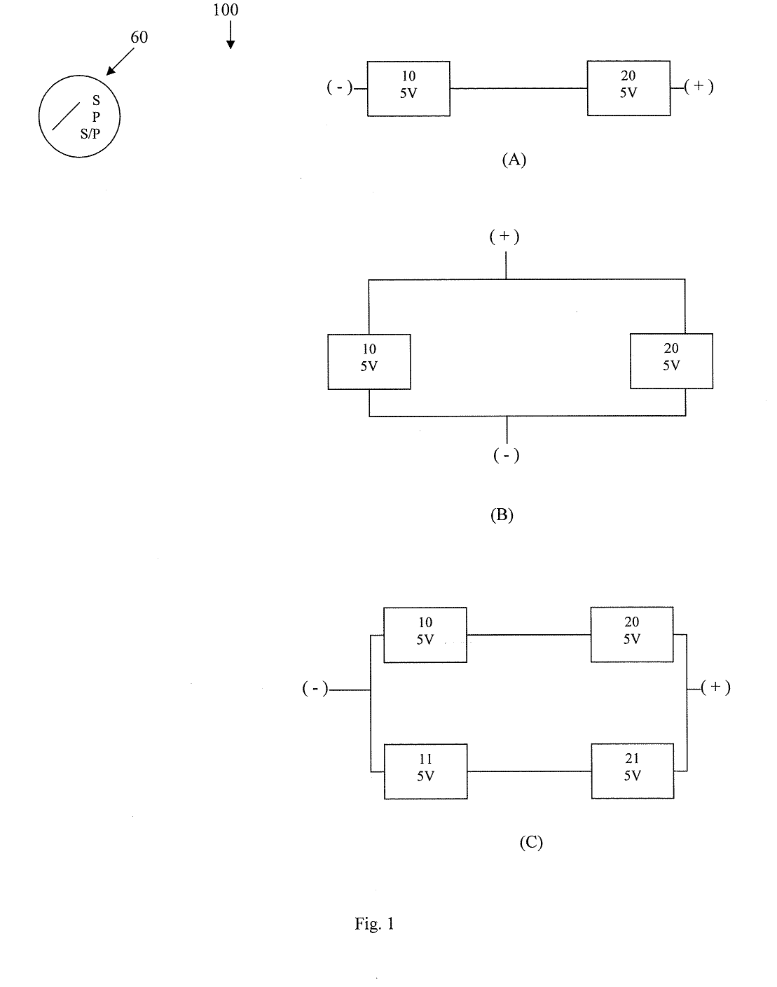

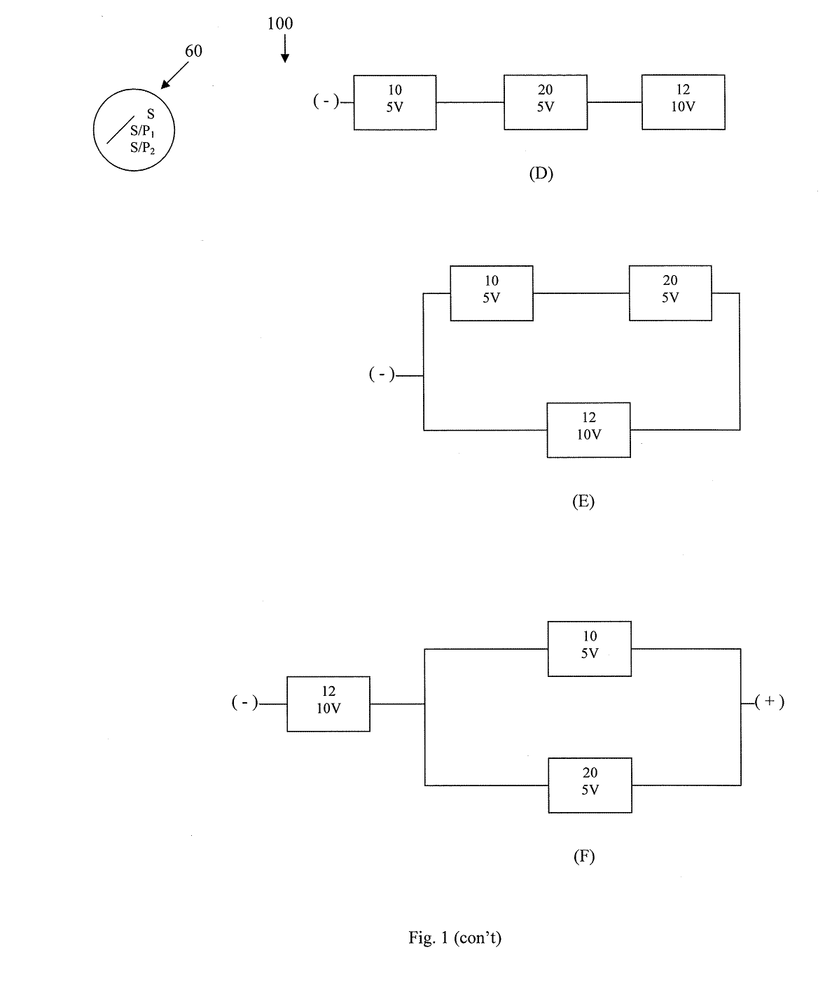

Turning to FIG. 1 A-C, a schematic of the serial, parallel, and serial/parallel configurations of the speed and power control mechanism for a battery powered DC motor with two and four batteries is shown, in accordance with an embodiment of the present invention. FIG. 1A-C shows a two speed/power (e.g., high and low) mechanism. The speed and power control mechanism for a battery powered DC motor 100 includes, but is not limited to a switch 60 structured to be able to select serial, parallel, and/or serial/parallel configurations, a Battery 10 and Battery 20 connected in series (see FIG. 1(A)), a Battery 10 and Battery 20 connected in parallel (see FIG. 1(B)), and a Battery 10, Battery 20, Battery 11, and Battery 21 in a serial/parallel configuration (see FIG. 1(C)). To obtain a higher voltage delivery/output (e.g., 10V) to a motor (not shown), the switch 60 is moved to the “S” position to choose the serial configuration shown by FIG. 1(A). To obtain a higher ampere-hour (and thus, longer lasting batteries, but a lower voltage delivery/output, e.g., 5V), the switch is moved to the “P” position to choose the parallel configuration shown by FIG. 1(B). A serial/parallel configuration may also be chosen, as shown in FIG. 1(C), which could also provide for a higher voltage delivery/output (e.g., 10V) to a motor when the switch 60 is moved to the “S/P” position.

Turning to FIG. 1D-F, a schematic of serial and serial/parallel configurations of the speed and power control mechanism for a battery powered DC motor with three batteries is shown, in accordance with an embodiment of the present invention. FIG. 1D-F shows a three speed/power (e.g., high, medium, and low) mechanism. The speed and power control mechanism for a battery powered DC motor 100′ includes, but is not limited to a switch 60 structured to be able to select serial, serial/parallel 1, and/or serial/parallel 2 configurations, a Battery 10, Battery 20, Battery 12 connected in series (see FIG. 1(D)), a Battery 10, Battery 20, Battery 12 in a series/parallel configuration (see FIG. 1(E)), and a Battery 10, Battery 20, Battery 12 in another series/parallel configuration (see FIG. 1(F)). To obtain the highest voltage delivery/output (e.g., 20V) in this embodiment to a motor (not shown), the switch 60 is moved to the “S” position to choose the serial configuration shown by FIG. 1(D). To obtain the lowest voltage delivery/output (e.g., 10V) in this embodiment to a motor (and thus, a higher ampere hour with longer lasting batteries), the switch is moved to the “S/P1” position to choose the serial/parallel configuration shown by FIG. 1(E). To obtain a medium voltage delivery/output (as compared with FIG. 1(D) and FIG. 1(E), e.g., 15V) in this embodiment to a motor, the switch is moved to the “S/P2” position to choose the serial/parallel configuration shown by FIG. 1(F).

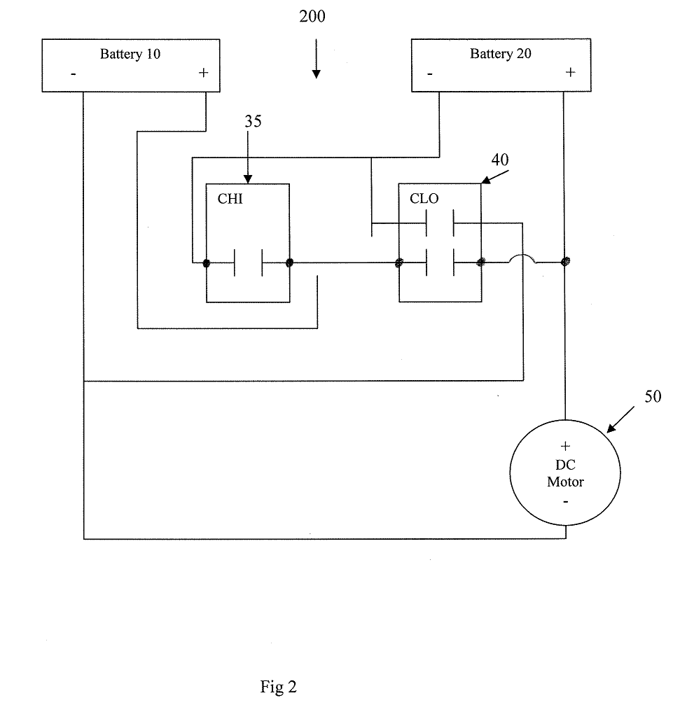

Turning to FIG. 2, a schematic of the circuitry of the speed and power control mechanism for a battery powered DC motor with two batteries is shown, in accordance with an embodiment of the present invention. The speed and power control mechanism for a battery powered DC motor 200 includes a Battery 10, a Battery 20, one set of CHI contacts 35, and two sets of CHO contacts 40. The DC powered motor 50 is also shown. When the set of CHI contacts 35 are closed, Battery 10 and Battery 20 are wired in series for maximum voltage delivery to the motor, and thus maximum power and speed delivery to the cutting blades and drive mechanism of a lawn mower. When the two sets of CHO contacts 40 are closed, Battery 10 and Battery 20 are wired in parallel for a lower voltage delivery to the motor, and thus a lower power and speed delivery to the cutting blades and drive mechanism of a lawn mower. It is contemplated by the present invention to include more contacts and batteries in the speed and power control mechanism for a battery powered DC motor of an embodiment of the present invention, and to place the additional batteries in various parallel and series configurations through the use of the contacts for various voltage delivery capacities. Another unique aspect of an embodiment of the present invention, is that the sum of all the batteries' power can always be utilized. All contacts are shown in the normally open position, but can be closed and opened as understood by those skilled in the art, and by means discussed herein.

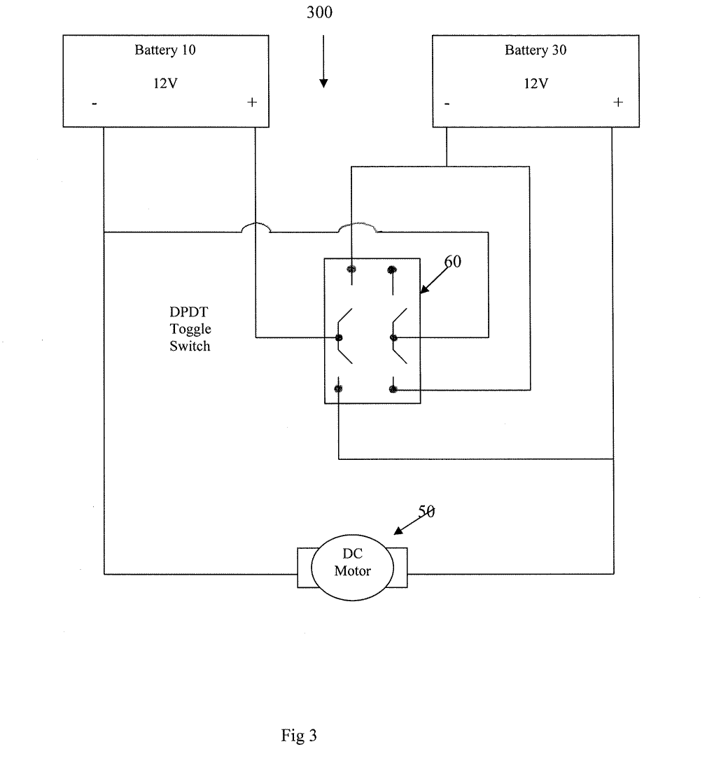

Turning to FIG. 3, a schematic of the circuitry of the speed and power control mechanism for a battery powered DC motor with two batteries and a toggle switch is shown, in accordance with an embodiment of the present invention. The speed and power control mechanism for a battery powered DC motor 300 includes a Battery 10, a Battery 20, and a toggle switch 60 (e.g., DPDT toggle switch). The switch rating can limit the power. The DC powered motor 50 is also shown. In this embodiment, the middle position of the toggle switch 60 can be the off position, and the switch can also be moved to apply 12 volts or 24 volts to the motor 50′, for example. For example, when the switch 60 is moved to close the top two contacts, only one contact is in play and the result is that the batteries are wired in series for a 24 volt result. When the switch 60 is moved to close the bottom two contacts, the batteries are wired in parallel for a 12 volt result.

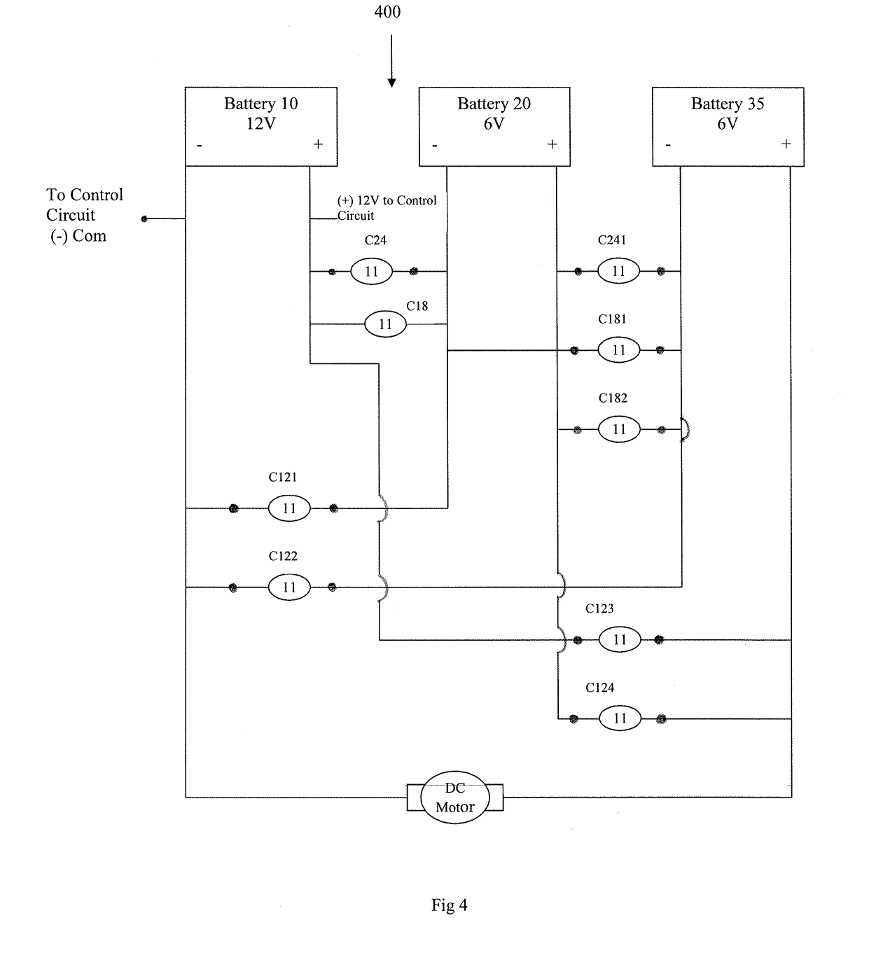

Turning to FIG. 4, a schematic of the circuitry of the speed and power control mechanism for a battery powered DC motor with three batteries is shown, in accordance with an embodiment of the present invention. The speed and power control mechanism for a battery powered DC motor 400 includes a Battery 10, a Battery 20, a Battery 30, contacts C121, C122, C24, C18, C241, C181, C182, C123, and C124. The DC powered motor 50 is also shown. All contacts are shown in the normally open position, but can be closed and opened as understood by those skilled in the art, and by means discussed herein. To apply 24 volts to the motor 50, contacts C24 and C241 should be closed placing the batteries in a series configuration. To apply 18 volts to the motor 50, contacts C18, C181, and C182 should be closed placing the batteries in a series/parallel configuration. To apply 12 volts to the motor 50, contacts C121, C122, C123, and C124 should be closed placing the batteries in a series/parallel configuration. All contacts are shown in the normally open position, but can be closed and opened as understood by those skilled in the art, and by means discussed herein.

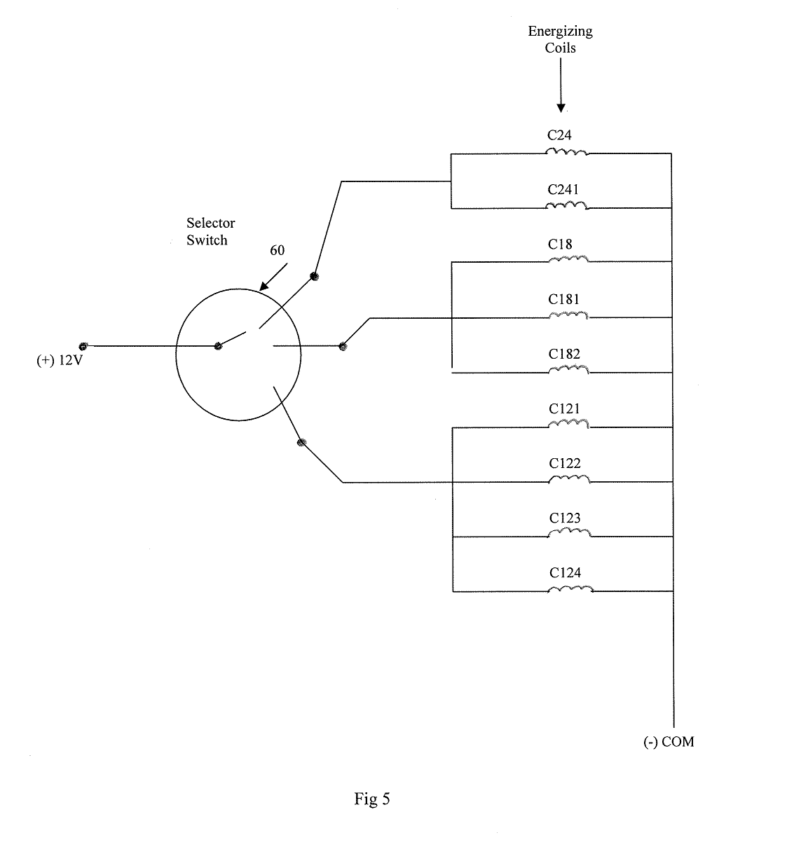

Turning to FIG. 5, a three battery control circuit, with respect to the three battery mechanism as shown in described with respect to FIG. 4 is shown, in accordance with an embodiment of the present invention. A selector switch 60 is shown, along with contacts (energy coils) C121, C122, C24, C18, C241, C181, C182, C123, and C124. The selector may select to close either contacts: (1) C24 and C241, (2) C18, C181, and C182, or (3) C121, C122, C123, and C124.

While several embodiments of the invention have been discussed, it will be appreciated by those skilled in the art that various modifications and variations of the present invention are possible. Such modifications do not depart from the spirit and scope of the present invention.

What is claimed is:

1. A speed and power control mechanism for a battery powered DC motor comprising:
at least a first battery and a second battery, wherein said first battery and said second battery are structured to be wired in a series configuration and a parallel configuration;
a selector means for selecting said series configuration or said parallel configuration; and
wherein when said series configuration is selected, a higher voltage delivery to said motor is obtained as compared to when said parallel configuration is selected.

2. The mechanism of claim 1, wherein said battery powered DC motor is a lawn mower motor.

3. The mechanism of claim 2, wherein when said series configuration is selected, a higher power output to a blade of said lawn mower is provided as compared to when said parallel configuration is selected.

4. The mechanism of claim 3, further comprising a first set of contacts between said first battery and said second battery, wherein said first set of contacts are structured to be closed by said switch, and wherein when said first set of contacts are closed said first battery and said second battery are wired in said series configuration.

5. The mechanism of claim 4, further comprising a second set of contacts and a third set of contacts between said first battery and said second battery, wherein said second set of contacts and said third set of contacts are structured to be closed by said switch, and wherein when said second set of contacts and said third set of contacts are closed said first battery and said second battery are wired in said parallel configuration.

6. The mechanism of claim 3, wherein said selector means comprises a selector means selected from the group consisting of a switch, a relay and a contractor.

7. The mechanism of claim 6, wherein said switch is a DPDT switch.

8. The mechanism of claim 7, further comprising a first set of contacts and a second set of contacts, wherein said first set of contacts and said second set of contacts are structured to be closed by said DPDT switch.

9. The mechanism of claim 8, wherein when said first set of contacts is closed said first battery and said second battery are wired in said series configuration.

10. The mechanism of claim 8, wherein when said second set of contacts is closed said first battery and said second battery are wired in said parallel configuration.

11. A speed and power control mechanism for a battery powered DC motor comprising:
a first battery, a second battery, and a third battery, wherein said first battery, said second battery, and said third battery are structured to be wired in a series configuration, a first series/parallel configuration, and a second series/parallel configuration;
a selector means for selecting said series configuration, said first series/parallel configuration, or said second series/parallel configuration; and
wherein when said series configuration is selected, a higher voltage delivery to said motor is obtained as compared to when said first series/parallel configuration is selected, or when said second series/parallel configuration is selected.

12. The mechanism of claim 11, wherein when said first series/parallel configuration is selected, a lower voltage delivery to said motor is obtained as compared to when said series configuration is selected or when said second series/parallel configuration is selected.

13. The mechanism of claim 12, wherein said battery powered DC motor is a lawn mower motor.

14. The mechanism of claim 13, wherein said series configuration is selected, a higher power output to a blade of said lawn mower is provided as compared to when said first series/parallel configuration is selected or when said second series/parallel configuration is selected.

15. The mechanism of claim 14, wherein when said first series/parallel configuration is selected, a lower power output to a blade of said lawn mower is provided as compared to when said series configuration is selected or when said second series/parallel configuration is selected.

16. The mechanism of claim 15, further comprising a first set of contacts between said first battery and said second battery, and a second set of contacts between said second battery and said third battery, wherein said first set of contacts and said second set of contacts are structured to be closed by said switch, and wherein when said first set of contacts and said second set of contacts is closed, said first battery, said second battery, and said third battery are wired in said series configuration.

17. The mechanism of claim 15, further comprising a first set of contacts between said first battery and said second battery, a second set of contacts between said first battery and said third battery, a third set of contacts between said first battery and said third battery, and a fourth set of contacts between said second battery and said third battery, wherein said first, second, third, and fourth sets of contacts are structured to be closed by said switch, and wherein when said first, second, third, and fourth sets of contacts are closed said first battery, said second battery, and said third battery are wired in said first series/parallel configuration.

18. The mechanism of claim 15, further comprising a first set of contacts between said first battery and said second battery, a second set of contacts between said second battery and said third battery, and a third set of contacts between said second battery and said third battery, wherein said first, second, and third sets of contacts are structured to be closed by said switch, and wherein when said first, second, and third sets of contacts are closed said first battery, said second battery, and said third battery are wired in said second series/parallel configuration.
